(19) United States
(12) Patent Application Publication
(10) Pub. No.: US 2016/0286141 A1
(43) Pub. Date: Sep. 29, 2016

(54) ALTIMETER USING IMAGING CAPABILITY

(71) Applicant: Rosemount Aerospace Inc., Burnsville, MN (US)

(72) Inventor: Todd A. Ell, Savage, MN (US)

(21) Appl. No.: 14/665,294

(22) Filed: Mar. 23, 2015

(51) Int. Cl. H04N 5/33; G01C 3/08; H04N 5/225; G01C 5/00

(52) U.S. Cl. CPC H04N 5/33; G01C 5/00; G01C 3/08; H04N 5/2256

(57) ABSTRACT

An altimeter includes a laser projector for projecting a pattern onto a surface and a camera for viewing the projected pattern. An image processor is operatively connected to the laser projector and camera for determining distance to the surface based on cross-correlation of the projected and imaged patterns. The camera can be a short wave infrared (SWIR) camera. The projected pattern can be a pseudo-random, fixed pattern.

### BACKGROUND OF THE INVENTION

1. Field of the Invention

The present disclosure relates to altimetry, and more particularly to methods and systems for optical altimetry.

2. Description of Related Art

Altitude above ground level (AGL) is an important consideration for all aspects of flight. For example, during critical phases of flight, many systems may need an indication of AGL altitude to perform properly. Further, AGL is important for weapon systems requiring an accurate, reliable and well-controlled burst height. One way to determine AGL is to use active radar altimeters which send a radar signal to the ground. However, traditional systems are expensive and require valuable space. Such conventional methods and systems have generally been considered satisfactory for their intended purpose. However, conventional AGL signals can potentially be distorted, intercepted, or the like, and may be inaccurate. As a result, there is still a need in the art for improved AGL altimeters. The present disclosure provides a solution for this need.

### SUMMARY OF THE INVENTION

An altimeter includes a laser projector for projecting a pattern onto a surface and a camera for viewing the projected pattern. An image processor is operatively connected to the laser projector and camera for determining distance to the surface based on cross-correlation of the projected and imaged patterns. The camera can be a short wave infrared (SWIR) camera. The projected pattern can be a pseudo-random, fixed pattern.

The image processor can be configured to determine correlation peaks between the imaged pattern and the expected pattern when the patterns align. A peak distance can be defined between a center of the projected pattern and a center of the imaged pattern. A height above the surface can be a function of a distance between the laser projector and the camera and the peak distance.

The laser projector and camera can be fixedly attached and co-boresighted such that resolution of the imaged pattern is scaleable to a resolution of the projected pattern. The image processor can be configured to control timing and repetition of the pattern emitted from the laser projector. The image processor can interface to a readout integrated circuit of the camera to control the exposure time and frame rate of the camera.

A method for determining distance to a surface includes projecting a pattern onto a surface from a laser projector and viewing the projected pattern using a camera to store an imaged pattern. The imaged pattern is cross-correlated with an expected pattern using an image processor operatively connected to the laser projector and camera.

The method can further include determining a correlation peak between the imaged pattern and expected pattern such that a peak distance is defined between a center of the projected pattern and a center of the imaged pattern. An optimal height above the surface can be calculated as a function of a distance between the laser projector and the camera and the peak distance. The method can further include controlling the repetition rate of the projected pattern and exposure of the camera with the image processor.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a block diagram of an exemplary embodiment of an altimeter constructed in accordance with the present disclosure, showing a camera and laser projector connected to an image processor;

FIG. 2 is a schematic view of the altimeter of FIG. 1, showing a projected image from the laser projector compared to an image viewed by the camera at different heights; and

FIG. 3 is a schematic view of a ranging triangle, showing an optimal height as a relationship between a distance between correlation peaks of the projected and viewed image and a distance between the camera and laser projector of FIG. 1.

### DETAILED DESCRIPTION OF THE PREFERRED EMBODIMENTS

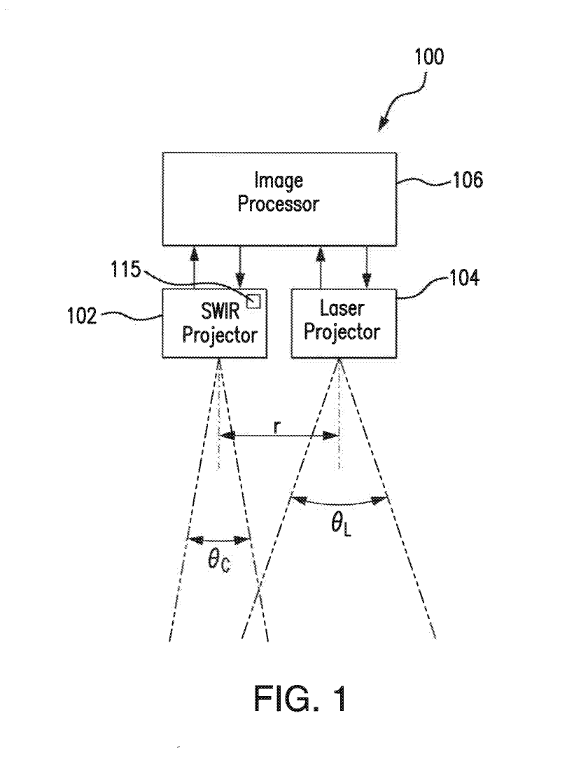

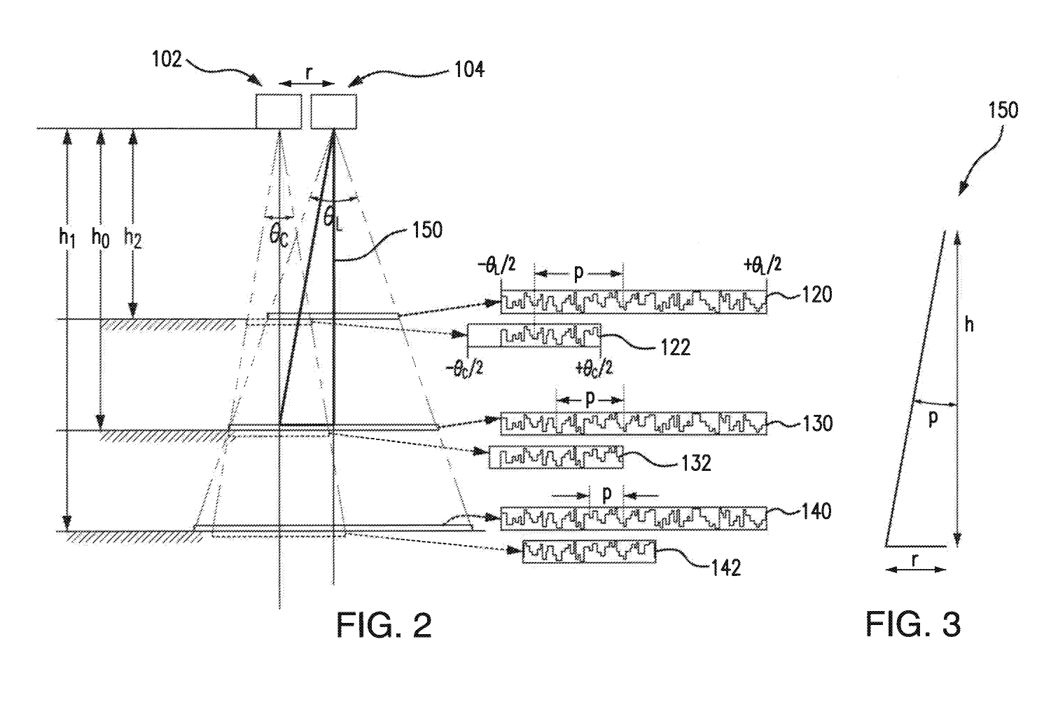

Reference will now be made to the drawings wherein like reference numerals identify similar structural features or aspects of the subject disclosure. For purposes of explanation and illustration, and not limitation, a partial view of an exemplary embodiment of an altimeter in accordance with the disclosure is shown in FIG. 1 and is designated generally by reference character 100. Other embodiments of the altimeter in accordance with the disclosure, or aspects thereof, are provided in FIGS. 2-3, as will be described. The systems and methods described herein can be used for altimetry, e.g., to exploit a weapon's seeker imaging capability to perform a height of burst (HoB) function.

The altimeter 100 is depicted in FIG. 1 and includes a camera 102, a laser projector 104, and an image processing system 106 operatively connected to both the camera 102 and the laser projector 104. The processing system 106 processes images from the camera 102 and controls the timing of the laser projector 104. The camera 102 is a short wave infrared (SWIR) camera, however, other cameras that can process a laser image can be used. The total field-of-view of the camera is denoted θ_{C} and the total field-of view of the laser projector is denoted θ_{L}. The camera 102 and the projector 104 are co-boresighted and have an offset displacement denoted as r. The laser projector 104 emits a single, fixed pattern, described below, which is viewed by the camera 102. The laser projector 104 can have a very low duty cycle and is active for very short durations (i.e., nanoseconds) at a varying repetition rate. The image processor 106 interfaces to the camera's 102 readout integrated circuit (ROIC) 115 to control the exposure time and frame rate of the camera 102. The image processor 106 is also capable of commanding the laser projector's 104 repetition rate and phasing relative to the camera's 102 exposure time. The image processor 106 also hosts a two-dimensional normalized cross-correlation algorithm, which attempts to register the images from the camera 102 as an expected pattern from the laser projector 104.

FIG. 2 depicts the overall operation of the altimeter of FIG. 1. Specifically, a pseudo-random (but fixed or predetermined) pattern 120 is projected onto the ground by an infrared laser of the laser projector 104 and viewed by the camera 102. The shift of the pattern in space is measured and then mapped to height through triangulation. Relying on this single-frame correspondence strategy, the altimeter 100 captures dynamic distance to the ground at the frame rate of the camera 102. Since the laser projector 104 and camera 102 are co-boresighted the projected pattern, as resolved on the ground, has the same resolution regardless of the height above the ground. The clarity of the pattern will degrade as the height increases due to distance-squared loss of laser energy and changes in the ground reflectivity as more of the ground surface is covered, but the pattern resolution scales with the camera's pixel resolution on the ground.

Shown in FIG. 2 is an example of projected patterns 120, 122, 124 across one row (or column) of the camera's image (from −θ_{L}/2 to +θ_{L}/2) and sub-portions of imaged patterns 122, 132, 142 as seen by the camera (from −θ_{C}/2 to −θ_{C}/2). At different heights, e.g., h₀, h₁, h₂, respectively, the resolution of the projected patterns 120, 122, 124 does not change, but which portion of the projected patterns 120, 122, 124 is seen by the camera 102 does, i.e., the imaged patterns 122, 132, 142 shift across the projected patterns 120, 122, 124. The imaged patterns are 122, 132, 142 cross-correlated with the expected projection patterns 120, 130, 140, to determine the correlation output peaks when the patterns align. A peak distance is determined at the point when the patterns align. The peak distance is defined as the distance from the center of the projected pattern to the center of the imaged pattern and is denoted p, as shown in FIG. 3. A ranging triangle 150 (shown as a bold line in FIG. 2 and FIG. 3) can be used to determine the altitude or height above the surface using the peak distance. The ranging triangle 150 includes a distance between a center point of the camera and the center of the laser projector lens r. The altitude or height above the surface is determined based on a function between the centers and the peak distance, as shown in equation (1):

$$h = \frac{r}{tan p} \qquad ( 1 )$$

Ideally the projected patterns 120, 130, 140 would be such that no sub-portion of the pattern correlates with any other sub-portion of the pattern. One such pattern is called a Maximum Length Sequence (MLS). An MLS is pseudo-random sequence which has a sharp and strong auto-correlation peak when the patterns are aligned, but low auto-correlation everywhere else. Since a large number of samples (pixels) are used (across the entire length of the image), the resulting correlation peak can be resolved using a standard correlation method at a finer resolution than the camera's pixel ground sample distance (GSD).

A two-dimensional MLS pattern can be projected to increase the number of samples in the correlation, making the system more robust to corruption in the projected pattern. Further, if a normalized cross-correlation algorithm is used, then the correlation angle is less sensitive to ambient light background variations across the image. Although because the system controls both the laser source timing and the exposure timing of the camera, the exposure can be made very short, reducing ambient levels in the resulting image, yet still capturing the laser energy.

The projector's field-of-view is made larger than the camera's field-of-view (θ_{L}>θ_{C}) so that beyond a predefined distance (e.g., h₀), the projected pattern spans the entire image taken by the camera. Although the cross-correlations at shorter distances will still work, the robustness and resolution of the correlation angle p will be degraded as only a portion of the image contains the projected pattern.

A method for determining distance to a surface using the altimeter of FIGS. 1 and 2 includes projecting a pattern onto a surface from a laser projector, e.g., laser projector 104, and viewing the projected pattern using a camera, e.g., camera 102, to store an imaged pattern. The imaged pattern is cross-correlated with an expected pattern using an image processor, e.g., image processor 106, operatively connected to the laser projector and camera. Based on the imaged pattern and the expected pattern a correlation peak is determined such that a peak distance is defined between a center of the projected pattern and a center of the imaged pattern. An optimal height above the surface can be calculated as a function of a distance between the laser projector and the camera and the peak distance.

The methods and systems of the present disclosure, as described above and shown in the drawings, provide for an altimeter with superior properties including use of imagining capability. This, in-turn, makes the system more reliable as there would be fewer components susceptible to failure. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. An altimeter comprising:
a laser projector for projecting a pattern onto a surface;
a camera for viewing the projected pattern; and
an image processor operatively connected to the laser projector and camera for determining distance to the surface based on cross-correlation of the projected and imaged patterns.

2. The altimeter of claim 1, wherein the camera is a SWIR camera.

3. The altimeter of claim 1, wherein the pattern is a pseudo-random, fixed pattern.

4. The altimeter of claim 1, wherein the image processor is configured to determine correlation peaks between the imaged pattern and the expected pattern indicating when the patterns align.

5. The altimeter of claim 4, wherein the image processor is configured to define a peak distance between a center of the projected pattern and a center of the imaged pattern.

6. The altimeter of claim 5, wherein the image processor is configured to determine height above the surface as a function of a distance between the laser projector and the camera and the peak distance.

7. The altimeter of claim 1, wherein the laser projector and camera are fixedly attached and co-boresighted such that resolution of the imaged pattern is scaleable to a resolution of the projected pattern.

8. The altimeter of claim 1, wherein the image processor is configured to control timing and repetition of the pattern emitted from the laser projector.

9. The altimeter of claim 8, wherein the image processor interfaces to a readout integrated circuit of the camera to control the exposure time and frame rate of the camera.

10. A method for determining distance to a surface, the steps comprising:
projecting a pattern onto a surface from a laser projector;
viewing the projected pattern using a camera and storing an imaged pattern; and
cross-correlating the imaged pattern with an expected pattern using an image processor operatively connected to the laser projector and camera.

11. The method of claim 10, further comprising determining correlation peaks of the imaged pattern and expected pattern such that a peak distance is defined between a center of the projected pattern and a center of the imaged pattern.

12. The method of claim 11, further comprising calculating a height above the surface as a function of a distance between the laser projector and the camera and the peak distance.

13. The method of claim 10, further comprising controlling the repetition rate of the projected pattern and exposure of the camera with the image processor.

14. The method of claim 10, wherein the camera is a SWIR.
